(19) United States
(12) Patent Application Publication
(10) Pub. No.: US 2025/0117077 A1
(43) Pub. Date: Apr. 10, 2025

(54) DISPLAY ROTATION TO INCREASE VIRTUAL FOV FOR FISH TANK-STYLE VR SYSTEM

(71) Applicant: Sony Interactive Entertainment Inc., Tokyo (JP)

(72) Inventors: Koichi Obana, San Mateo, CA (US); Yuichiro Nakamura, San Mateo, CA (US); Greg Corson, San Mateo, CA (US)

(21) Appl. No.: 18/484,409

(22) Filed: Oct. 10, 2023

(51) Int. Cl. G06F 3/01; G06F 3/14

(52) U.S. Cl. CPC G06F 3/013; G06F 3/1446

(57) ABSTRACT

Techniques are described for rotating a display such as multiple displays of a box-shaped flat panel display assembly according to the viewing angle of the user.

### FIELD

The present application relates to technically inventive, non-routine solutions that are necessarily rooted in computer technology and that produce concrete technical improvements, and more specifically to four-sided display assemblies for mixed reality.

### BACKGROUND

As understood herein, so-called “fish tank” display assemblies have been provided. Such assemblies render the image on the display coupled to the head position of the observer as if he/she looks into a fish tank. One display may be used for this purpose, or plural flat panel displays arranged in a box-shaped configuration may be used. Either way, the display(s) can be controlled to produce images as if seen in a fish tank.

### SUMMARY

As further understood herein, a user typically will move about a fish tank display while viewing it, which can reduce the amount of display he sees.

Accordingly, an apparatus includes at least one processor assembly configured to determine a viewing angle of a person to at least a first display, and to use the first viewing angle to turn the first display.

In some aspects, the first display can include a liquid crystal display (LCD). Or, the first display may be a projection display or a light emitting diode (LED) display. The first display may be part of a multi-display assembly that can be box-shaped.

In example embodiments the processor assembly can be configured to turn the first display in one or more of a pitch dimension defined by the first display, a yaw dimension defined by the first display, and an azimuthal dimension defined by the first display.

In an example implementation the processor assembly may be configured to turn the first display according to the viewing angle responsive to an image of the person indicating that the eyes of the person are closed, and not turn the first display according to the viewing angle responsive to an image of the person indicating that the eyes of the person are open.

In another aspect, an apparatus includes at least one computer medium that is not a transitory signal and that in turn includes instructions executable by at least one processor assembly to determine a location of a person viewing a display, and to use the location to turn the display toward the location.

In another aspect, a method includes receiving at least one signal indicating a location of a person. The signal may originate from, e.g., one or more cameras or one or more microphones. The method includes using the signal to determine a direction to turn a display, and turning the display according to the direction.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 illustrates an example multi-display assembly;

FIG. 3 illustrates schematically the pixels of a display;

FIG. 4 illustrates a perspective view of an example embodiment;

FIG. 5 illustrates a front elevational view of another example;

FIG. 6 illustrates a side elevational view of the embodiment shown in FIG. 5;

FIG. 7 illustrates a top plan view of the embodiment shown in FIG. 5;

FIG. 8 schematically shows a display being turned to follow a viewer;

FIG. 9 illustrates example logic in example flow chart format consistent with present principles; and

FIGS. 10A-10C show schematics of a display on a robot arm moving according to a person's head position and a virtual position of a virtual object.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

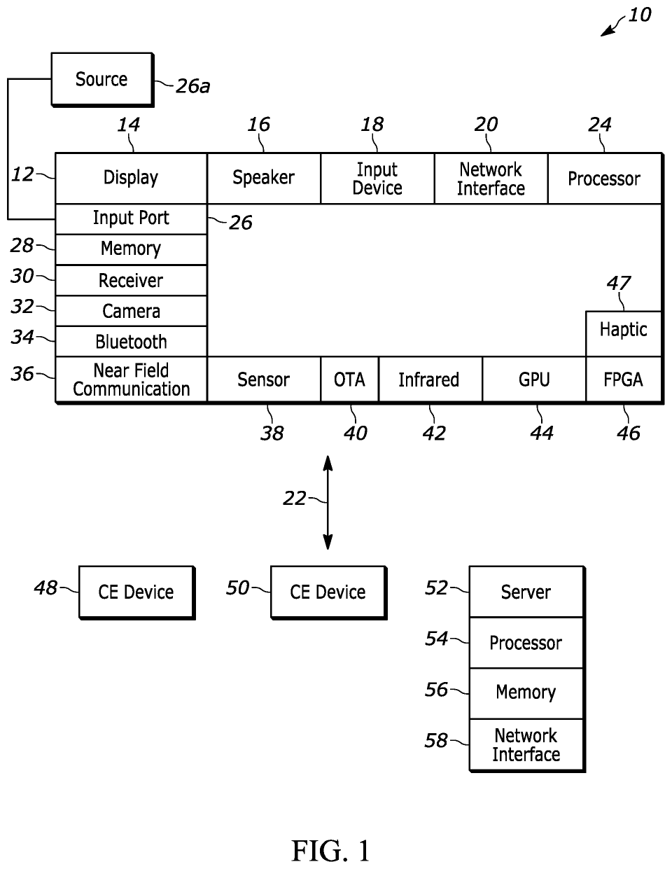

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

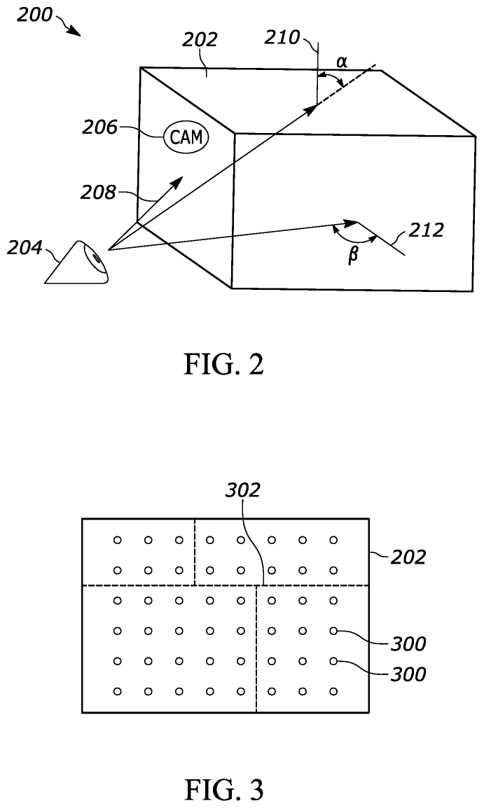

FIG. 2 illustrates at least one flat panel display 202 that may be a standalone display or part of a multi-display assembly 200 which has plural flat panel displays 202. Whether a single display is used or a multi-display assembly is used, present principles provide higher field of views (FOVs) to a viewer by moving the display in consonance with the viewer location.

In the example shown, the display assembly is parallelepiped-shaped/box-shaped and thus has four side displays and one top display arranged on an open or solid base, to resemble a fish tank. Other configurations are contemplated. Each of the displays 202 may be flat panel display such as liquid crystal displays (LCD) or light emitting diode (LED) displays or projection displays such as disclosed in commonly-owned U.S. Pat. No. 11,520,217, incorporated herein by reference. In any case, as set forth in detail herein, the location of the user 204 relative to the display and in particular relative to the screen of the assembly closest to the user as determined from, e.g., signals from one or more sensors 206 (such as images from one or more cameras or acoustic signals from one or more microphones that may be part of the assembly 200) that can be used to turn the assembly toward the user.

FIG. 3 illustrates a display 202 of the assembly 200 which includes plural pixels 300, which may be divided into groups of pixels as illustrated by the dashed lines 302.

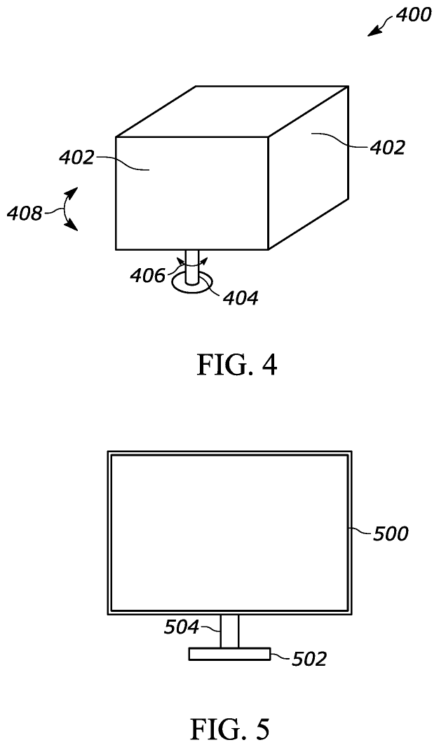

FIG. 4 schematically illustrates a fish tank-like display assembly 400 with plural flat panel displays 402 arranged in a box-shaped configuration. The assembly 400 is movably supported on a mount 404 configured to rotate the assembly back and forth in the yaw dimension as indicated by the arrows 406. The mount 404 also may be configured to rotate the assembly 400 up and down in the pitch dimension as indicated by the arrows 408. The mount 404 may be activated to rotate the assembly 400 as appropriate to maintain one of the displays 402 facing directly at a moving user.

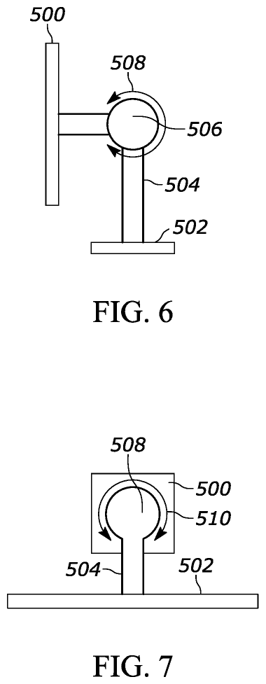

FIGS. 5-7 illustrate an embodiment depicting a single flat panel display 500, it being understood that a box-shaped fish tank-style display assembly equally may be mounted as shown in place of a single display 500. The display 500 is supported on a base 502 by an L-shaped mount 504. The mount 504 may have a computer-controlled actuator 506 such as a stepper motor or brushless or brushed DC motor or coreless motor or geared motor powered by one or more batteries or powered from the electrical grid through, e.g., a transformer that is configured to rotate the display 500 up and down in the pitch dimension as indicated by the arrows 508 (FIG. 6). In addition or alternatively the motor 506 may be configured to rotate the display 500 left and right in the yaw dimension and/or azimuthal dimension as indicated by the arrows 510 (FIG. 7).

Note that the display doesn't necessarily have to move automatically with actuators. The display can be moved manually as long as the processor controlling the display can know how much the display has moved based on motion and/or position sensors mounted on or otherwise coupled to each of the pitch, yaw, and azimuthal axes of the display.

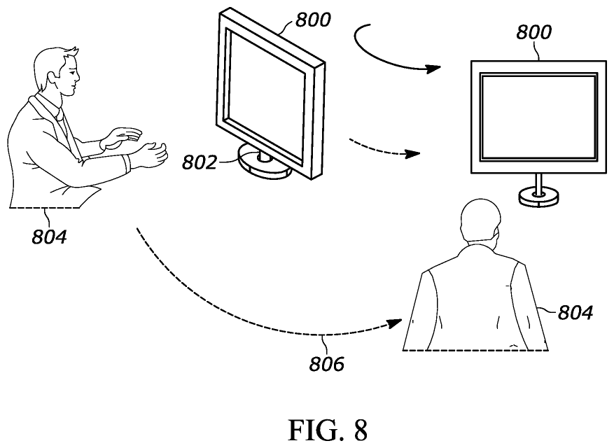

FIG. 8 illustrates a display 800 such as any one or more displays divulged herein on a support 802 that moves the display 800 to directly face a user 804 as the user moves as indicated by the arrow 806. Thus, if the user moves sideways the display 800 is turned toward the user left or right. If the user is standing and sits down the display pitches downwardly to directly face the head of the user.

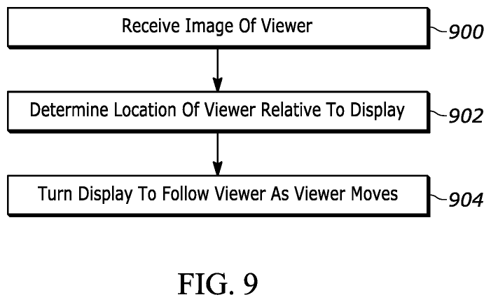

FIG. 9 illustrates example logic undertaken by any of the movable display assemblies herein. Commencing at state 900 an image of the user is received. The image may be a voice image and/or a camera image from whence is derived a direction to the head of the user relative to the display at state 902. The display is turned at state 904 toward the direction of the user determined at state 902.

Note that movement of the display according to movement of the user's head do not have to match completely as long as the pictures on the display are linked with head movement and the actuator angle.

Note further that movement of the display at state 904 may be limited only to periods in which imaging of the user captures the user blinking. When the user blinks, the eyes are closed, and the user will not be able to see the display move. When the user is not blinking, the eyes are open, and the display may be prevented from moving to track the user during these periods. In other words, the display may be moved to track the user only during periods when imaging of the user indicates that the user's eyes are closed. Or in other examples, the display may continually move both when the user is blinking and not blinking, but may accelerate its movement to move faster during times of detected blinks.

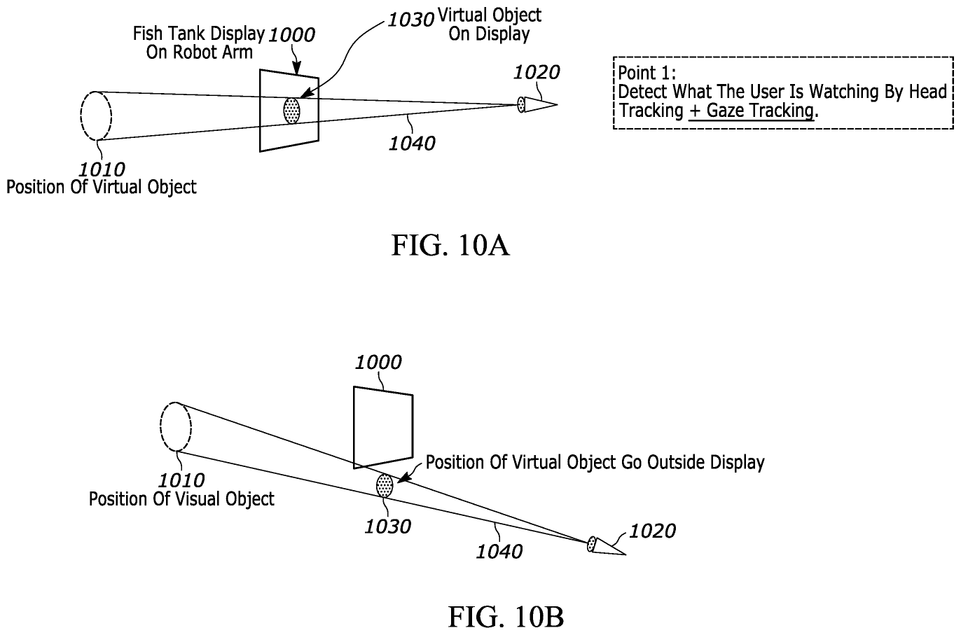

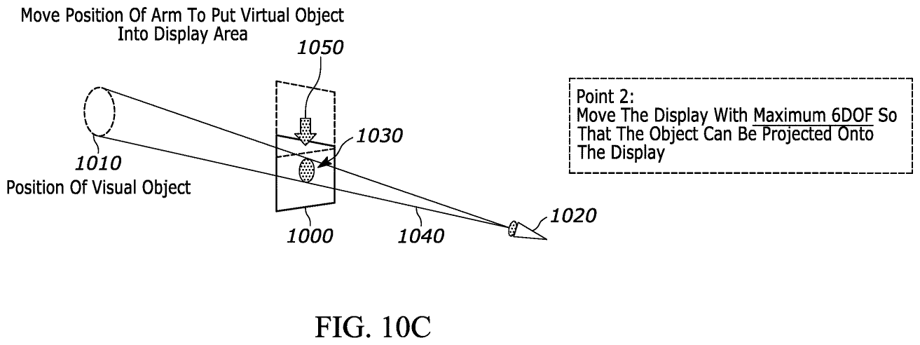

Turning now to FIGS. 10A-10C, these schematic drawings further illustrate present principles. As shown in FIG. 10A, a fish tank display 1000 is shown that may be similar to the display 500 mentioned above. As such, the display 1000 may be coupled to a base like the base 502 by an L-shaped mount like the mount 504. The mount may have a computer-controlled actuator like the actuator 506. The display 1000 may therefore rotate using a robot arm consistent with present principles.

As also shown in FIG. 10A, a virtual 3D position 1010 of a virtual object 1030 is shown as viewable by the eyes 1020 of an end-user via the display 1000. The virtual 3D position 1010 may correspond to a 3D real-world position at which the virtual object 1030 appears to the user (as presented on the display 1000). A current viewing angle 1040 of the eyes 1020 toward the position 1010 is therefore also shown in FIG. 10A to indicate as much.

As indicated by the inset box of FIG. 10A, the system can detect what the user is viewing/watching on the display 1000 using camera input along with head tracking and/or gaze tracking. In the present instance, the system has determined that the user is viewing the object 1030 as represented as being located at the position 1010 in 3D space. Owing to the current viewing angle 1040 passing through the object 1030 as presented on the display 1000, the user can adequately view the object 1030 at its virtual position 1010 via the fish tank display 1000.

However, as shown in FIG. 10B, the current viewing angle 1040 has subsequently changed. As a result, the object 1030 is no longer visible at its virtual position 1010 via the display 1000, as the position 1010 of the object 1030 is now outside the area of the display 1000 according to the angle of view 1040. Per FIG. 10B, the object 1030 is therefore not presented on the display 1000 at all.

In response to the system detecting the object 1030 no longer being visible at its virtual position 1010, FIG. 10C and arrow 1050 in particular show that the system may actuate the robot arm to which the display 1000 is coupled to move the display 1000 downward, putting the virtual object 1030 (according to its virtual position 1010) in the display area. Accordingly, the system moves at least part of the display 1000 into the current viewing angle 1040, moving the display with a maximum of six degrees of freedom so that the object 1030 can be projected onto the display 1000 itself according to the position 1010 (e.g., displayed in the viewing angle 1040 at a particular display location and 3D appearance so that it appears at its virtual position 1010). It is to be understood that in the embodiments herein, the displays/assemblies/mounts may include some or all of the appropriate components shown in FIG. 1 for controlling orientation of the display to face the user according to camera images or if desired according to sound triangulation from microphones detecting sound from the user.

While particular techniques are herein shown and described in detail, it is to be understood that the subject matter which is encompassed by the present application is limited only by the claims.

1. An apparatus comprising:
at least one processor assembly configured to:
determine a first viewing angle of a person to at least a first display;
use the first viewing angle to turn the first display responsive to an image of the person indicating that the eyes of the person are closed, and not turn the first display according to the viewing angle responsive to an image of the person indicating that the eyes of the person are open.

2. The apparatus of claim 1, wherein the first display comprises a liquid crystal display (LCD).

3. The apparatus of claim 1, wherein the first display is part of a multi-display assembly that is box-shaped.

4. The apparatus of claim 1, wherein the processor assembly is configured to turn the first display in a pitch dimension defined by the first display.

5. The apparatus of claim 1, wherein the processor assembly is configured to turn the first display in a yaw dimension defined by the first display.

6. The apparatus of claim 1, wherein the processor assembly is configured to turn the first display in an azimuthal dimension defined by the first display.

7. (canceled)

8. An apparatus comprising:
at least one computer medium that is not a transitory signal and that comprises instructions executable by at least one processor assembly to:
determine a location of a person viewing a display; and
use the location to turn the display toward the location at a first speed responsive to an identification of at least one eye of a person being closed and at a second speed responsive to an identification of at least one eye of a person being open.

9. The apparatus of claim 8, wherein the display is part of a multi-display assembly.

10. The apparatus of claim 8, wherein the display comprises a liquid crystal display (LCD).

11. The apparatus of claim 9, wherein the multi-display assembly is box-shaped.

12. The apparatus of claim 8, wherein the instructions are executable to turn the display in a pitch dimension defined by the display.

13. The apparatus of claim 8, wherein the instructions are executable to turn the display in a yaw dimension defined by the display.

14. The apparatus of claim 8, wherein the instructions are executable to turn the display in an azimuthal dimension defined by the display.

15. The apparatus of claim 8, wherein the instructions are executable to:
turn the display according to the viewing angle responsive to an image of the person indicating that the eyes of the person are closed, and otherwise prevent turning the display.

16. A method, comprising:
identifying a virtual position of a virtual object on a display, the virtual position corresponding to a real-world position at which the virtual object appears to a viewer of the display;
identifying a direction of gaze of the viewer; and
responsive to a change of a viewing angle between the direction of gaze and the virtual object,
turning the display.

17, 18. (canceled)

19. The method of claim 16, wherein the display is part of a multi-display assembly.

20. The method of claim 19, wherein the multi-display assembly is box-shaped.
